(19) United States
(12) Patent Application Publication
(10) Pub. No.: US 2005/0048173 A1
(43) Pub. Date: Mar. 3, 2005

(54) Method of smoking fish

(76) Inventors: Stanley R. Hubbard, Douglas, AK (US); Roberta J. Hubbard, Douglas, AK (US)

Correspondence Address: LITMAN LAW OFFICES, LTD., P.O. BOX 15035 CRYSTAL CITY STATION, ARLINGTON, VA, 22215, US

(21) Appl. No.: 10/646,693

(22) Filed: Aug. 25, 2003

(51) Int. Cl. A23C 1/00

(52) U.S. Cl. 426/315

(57) ABSTRACT

The apparatus and method of packaging smoked fish fillets requires a flat or cambered raised wire smoking rack with spaces between wires cooperating with the spaced cutting edges of the parallel knives positioned in front of a working platform arm device. The working arm device comprises a planar backing surface tray supported by a wire support, a lower arm cuff, and a hinged upper arm cuff on rod supports that attach to the worker's uniform. The system enables safe and efficient removal of smoked fish fillets from its rack without injury to the smoked product and the worker.

### BACKGROUND OF THE INVENTION

1. Field of the Invention

The present invention relates generally to smoking fish. More specifically, the invention is an apparatus combination used to place on and remove fish from a smoking rack.

2. Description of the Related Art

The relevant art of interest describes various methods of smoking fish, but none discloses the present method and apparatus for performing the fish smoking process of the present invention. There is a need for a working platform arm device for removing smoked fish fillets from a rack that would not result in injury to the worker. The related art of interest describes various methods of packaging smoked fish, but none discloses the present device and method of use.

European Patent Application No. EP 0 824 868 A1 published on Feb. 25, 1998, for Henricus A. J. M. Bond describes a method and system for preparing a ready-to-use fish product and the product comprising in the process, the steps of pre-treating the fish, smoking the pre-treated fish, cutting the smoked fish into ready-to-use products such as single-bite servings, freezing and packing the cut fish products. The system comprises a pre-treatment station, a smoking station, a cutting station, a freezing station, and a freezing station arranged in series. The cutting station may comprise a cutting device having one or more movably driven cutting members, e.g., a plurality of parallel rotatable cutting members, between which wiping members may be arranged. The system is distinguishable for requiring five treating stations in sequence, and requiring a cutting device and wiping members.

U.S. patent application Publication Ser. No. 2002/0189603 A1 published on Dec. 19, 2002, for Josephine Hsu describes a barbeque smoking grill having a porous separator for smoking and grilling multiple food items simultaneously with separate lids. The apparatus is distinguishable for requiring a smoking grill but failing to specify any device similar to the present invention for removing the smoked items from the grill.

U.S. Pat. No. 4,148,925 issued on Apr. 10, 1979, to F. Edward Pettinato et al. describes a process for hot smoking fish comprising the conversion of the fish skinto a moisture impervious state under non-cooking conditions, and then cooking the fish in the presence of smoke while maintaining the moisture impervious nature of the fish skin. The method is dissimilar and the cooking utensils are conventional.

U.S. Pat. No. 6,068,314 issued on May 30, 2000, to Gery D. Dorazio et al. describes a wire rack handling tool comprising having a triangular metal blade narrowing to a vertically bent neck having a pair of hooks on a handle. The tool is distinguishable for its different spatula structure.

U.S. Pat. No. 5,823,589 issued on Oct. 20, 1998, to Brad Johnston describes a food-handling accessory for a charcoal grill comprising a unique pivoting structure to rotate a tined array about a center axis to allow relatively fragile food items such as fish to be turned over and removed from the grill surface without sticking or breaking apart. Hooks are formed at the ends of the outside tine members. The device is distinguishable for requiring a rotating tine portion with hook members.

U.S. Pat. No. 5,941,584 issued on Oct. 24, 1999, to Mark J. Young et al. describes a roast lifting tool comprising a pair of metal tines spaced apart on a short handle having a T-shaped metal grasping handle at the juncture of the tines and the handle. The tool is distinguishable for lacking the structure of the present invention, and being limited to the tines and handle.

U.S. Pat. No. 3,761,120 issued on Sep. 25, 1973, to Charles E. Binkert describes a food patty-turning device comprising a spatula-like tool having an open flanged frame hinged over a slotted flat blade for grasping a food patty by the action of a bell crank and trigger on a wooden handle having a loop at its end for holding the bell crank in a closed position by engaging the trigger. The device is distinguishable for requiring a flanged open frame to clamp on the slotted flat blade by a bell crank and trigger control.

U.S. Pat. No. 4,029,004 issued on Jun. 14, 1977, to Edward Isenberg describes a meat curing or smoking rack comprising a rectangular vertical rack frame having spring-like brackets for supporting shelves in either a horizontal meat supporting position or a relatively vertical washing and storage position, pans on the frame in underlying positions to the shelves for collecting curing and other solutions which drain from the shelved meat, and pivoting means mounting the pans for movement between a horizontal solution-collecting position and a vertical pan-washing position. The curing racks travel on a rail with journaling wheels to form a trolley. The rack device is distinguishable for requiring multiple shelves on a vertical rack.

Japanese Patent Application Publication No. JP 1-10893 A, published on Apr. 4, 1989, for Kanichi Hayano describes a smoking process of salmon by slicing salmon into three fillets, skinning the fillets, leaving a tail part, and hanging the fillets by piercing wires through the unskinned part. The process is distinguishable by requiring hanging the fillets by their unskinned tail portion.

Japanese Patent Application Publication No. JP 10-192165 A, published on Jul. 28, 1998, for Shoichi Kumakura describes a one-piece tong-shaped stainless steel spatula having a holding function for turning over baked food. The upper spatula's tip has saw-teeth. The device is distinguishable for requiring only a certain structure for the tong.

None of the above inventions and patents, taken either singly or in combination, is seen to describe the instant invention as claimed. Thus, a method of packaging smoked fish using the novel drying rack solving the aforementioned problems is desired.

### SUMMARY OF THE INVENTION

The method of packaging smoked fish fillets includes the removal of smoked fillets from a novel planar or cambered smoking rack and a removal tool or apparatus. This processing step requires the delicate but efficient task of separating the smoked fillets from the rack without damaging the product. Another problem occurs due to the removal of most if not all of the smoked product from the smoking rack simultaneously without any undue physical effort on the part of the employee. Therefore, this inventive combination apparatus has been devised to eliminate the aforementioned problem with minimum effort and maximum economy. The working platform arm apparatus comprises a rectangular backing surface tray either planar or cambered (upwardly curved) and supported underneath by a wire grid frame that is attached to a horizontal lower arm element having an external curvilinear lower arm cuff or guard. The lower arm element is adjustably hinged at one end to the end of doubled and overlapping upper arm support rods that are attached to another curvilinear external rod support described as an upper arm cuff. The front end of the backing surface tray has attached a knife section board having a specially formed parallel series of thin flat knives having frontal cutting edges. The spacing of the sharp knife edges conform with the parallel spacing of the rack wires to efficiently separate the smoked filets from the rack. Therefore, the operator utilizing the working platform arm device can efficiently and effectively separate and collect the smoked fillets.

Accordingly, it is a principal object of the invention to provide a method of packaging smoked fish fillets.

It is another object of the invention to provide an apparatus for smoking fish fillets.

It is a further object of the invention to provide a protective arm apparatus for removing smoked fillets from its rack.

Still another object of the invention is to provide the rack in two configurations as flat and upwardly curved.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental top plan view of a planar raised wire smoking rack of a first embodiment supporting salmon fillets according to the present invention.

FIG. 2 is a top plan view of the FIG. 1 planar rack.

FIG. 3 is an elevational side view of the FIG. 1 planar rack.

FIG. 4 is an elevational end view of the FIG. 1 planar rack.

FIG. 5 is a side elevational view of a second embodiment fish smoking rack having an arcuate or cambered configuration and using spring powered rack clips of a first embodiment to secure the ends of the fish fillet.

FIG. 6 is a top plan view of the first embodiment of a spring-powered clip having two finger hooks to pierce only the skin or a collar of the fish.

FIG. 7 is a top plan view of a second embodiment of a spring-powered alligator clip having a handle for guiding the fillet onto a platform arm of the FIG. 8 device.

FIG. 8 is an exploded elevational view of a working platform arm device without the knife section.

FIG. 9 is a partial top plan view of the working platform arm's knife section about to remove the smoked fillets from the rack.

Similar reference characters denote corresponding features consistently throughout the attached drawings.

### DETAILED DESCRIPTION OF THE PREFERRED EMBODIMENT

The present invention is directed to two embodiments of a smoking rack for fish fillets and a working platform arm device for a worker to wear and use in removing the smoked fillets efficiently in one movement from the smoking rack and transporting elsewhere.

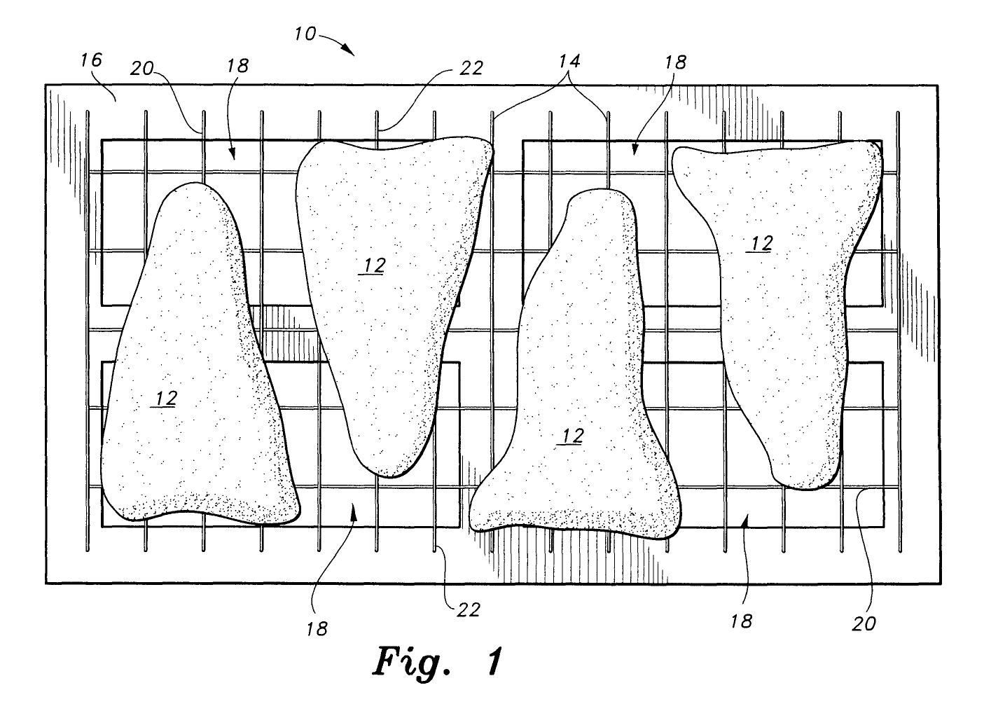

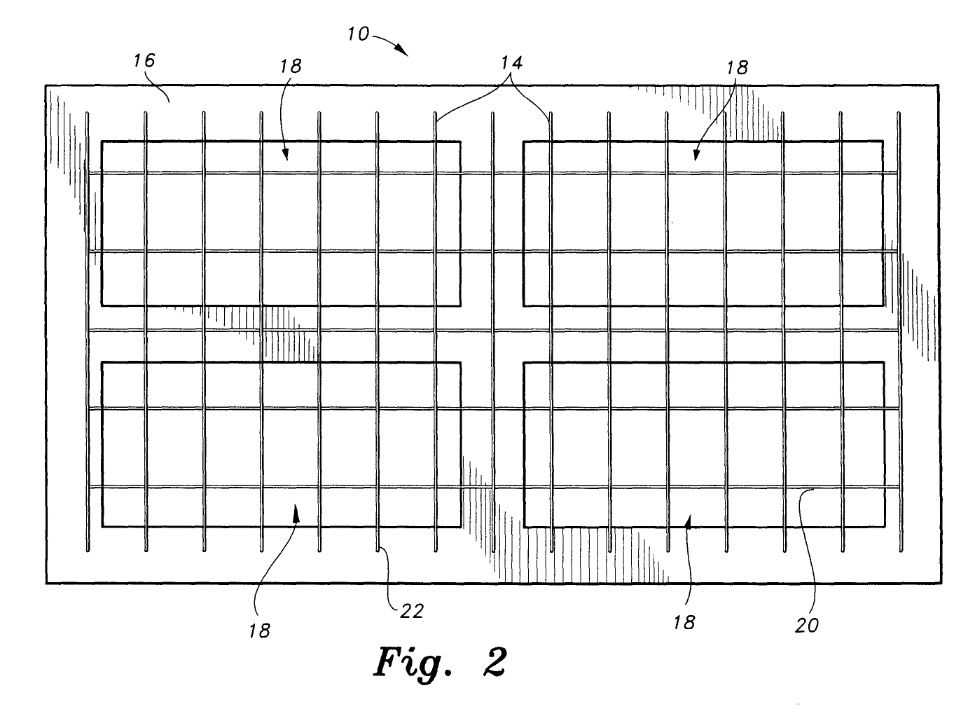

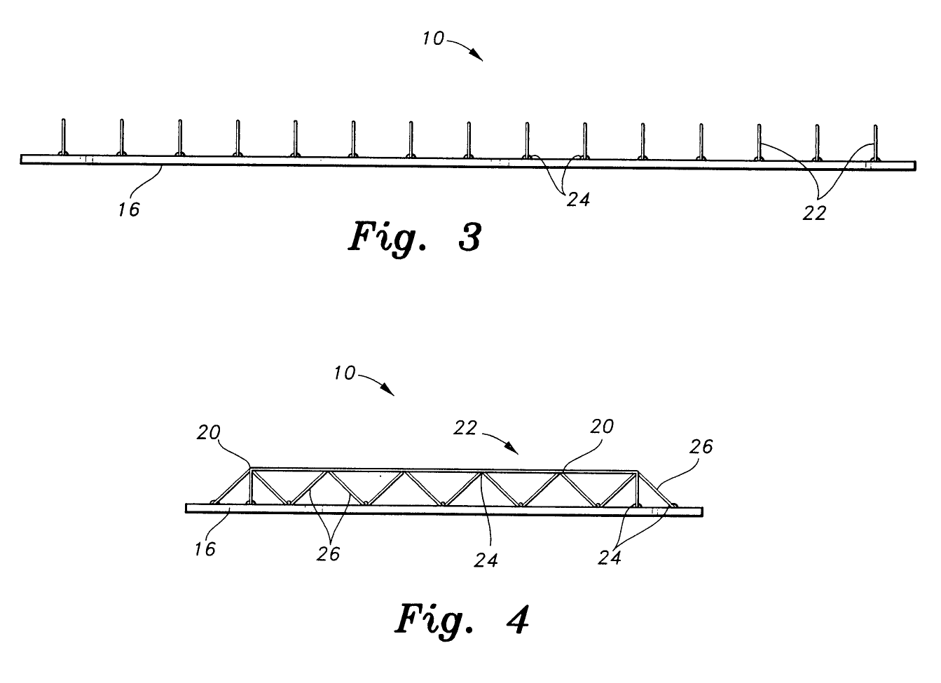

In FIGS. 1 and 2, a first embodiment of a planar smoking rack 10 is illustrated having four salmon fillets 12 (FIG. 1) placed on an elevated steel wire grid 14 welded to a rectangular steel frame 16 having four rectangular openings 18. The wire grid 14 consists of longitudinal wires 20 and width wires 22. In the side view depicted in FIG. 3, the frame 16 has the width wires 22 welded by solder beads 24 (ground smooth) to the frame 16 and depicted equidistantly apart. In the end view in FIG. 4, the diagonal supporting wires 26 as gap stabilizing ends are also welded to the frame 16 and the overlying width wires 22 to form a rigid frame.

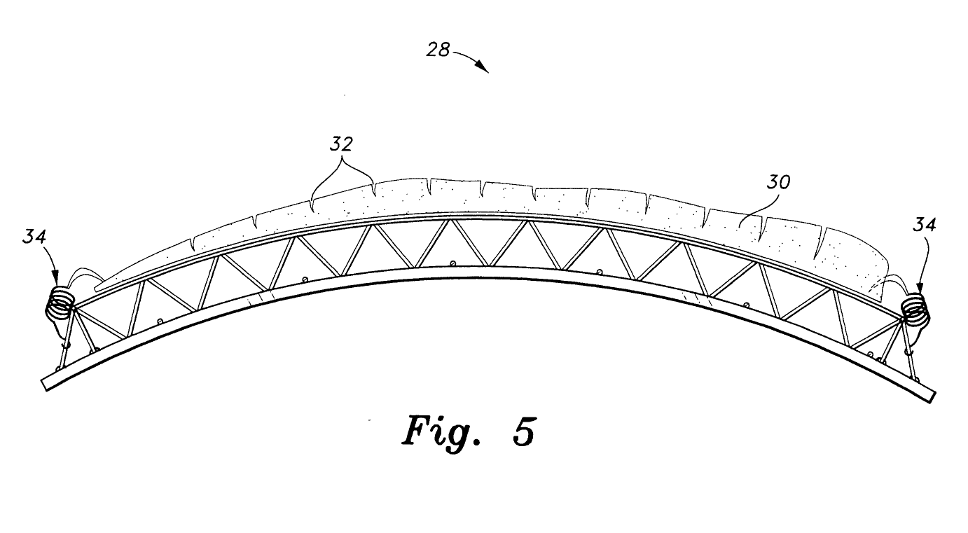

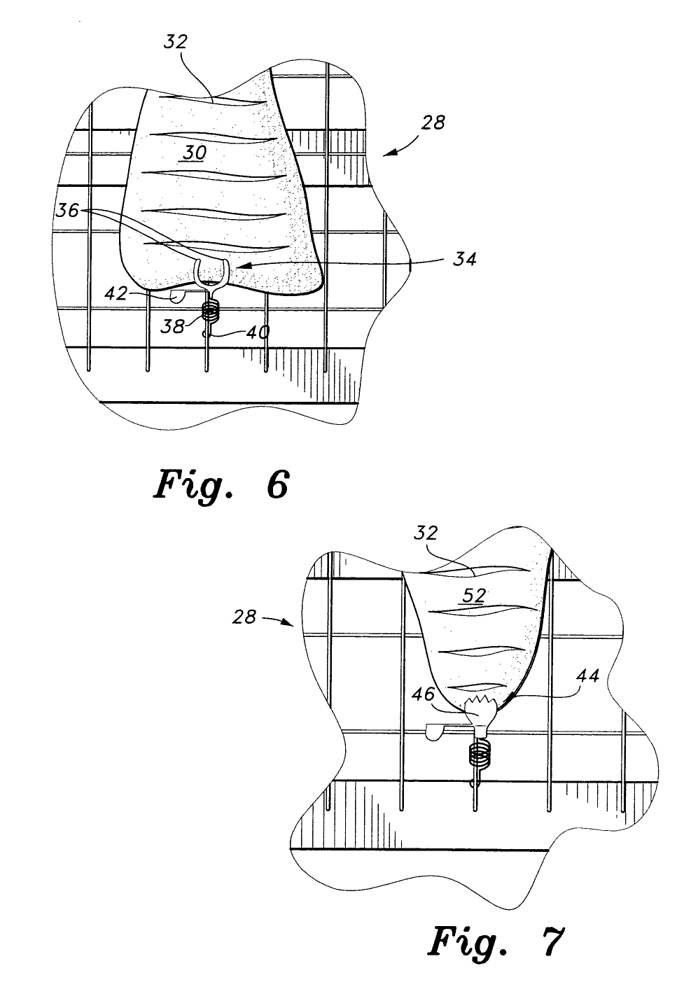

FIG. 5 is drawn to a second embodiment of a cambered raised wire smoking rack 28 having a single large fish fillet collar 30 that has been sliced widthwise with cuts 32 and anchored at its ends by a first alternative rack clip 34 depicted in FIG. 6 as having a two-fingered hook 36 attached to a spring 38 ending in a second single end hook 40, and a spring release handle 42. The handle 42 also performs a function of guiding the fillet 30 onto a platform arm to be discussed below. This rack clip 34 is preferably utilized for collars of the fish.

FIG. 7 is drawn to a second alternative alligator rack clip 44 having an alligator type clamping jaw 46 controlled by a hidden spring, a handle 48 attached to the jaw 46 for releasing the jaw grip, and a spring 50 ending in a hook 52 for attachment to the rack 28. This rack clip 44 is preferably utilized for fish tails 52.

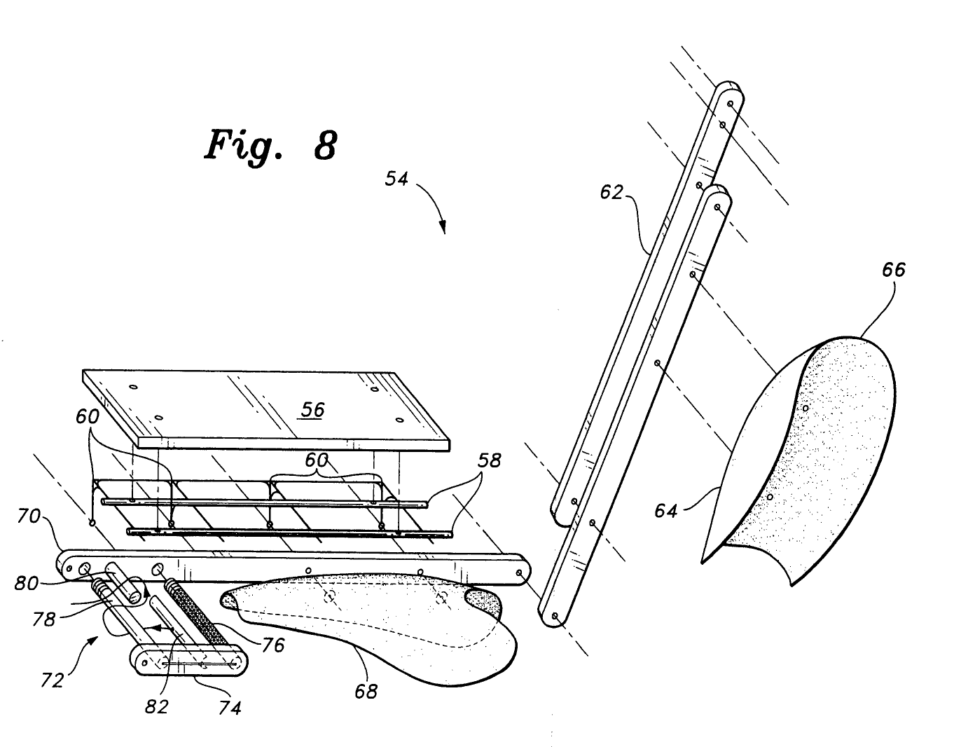

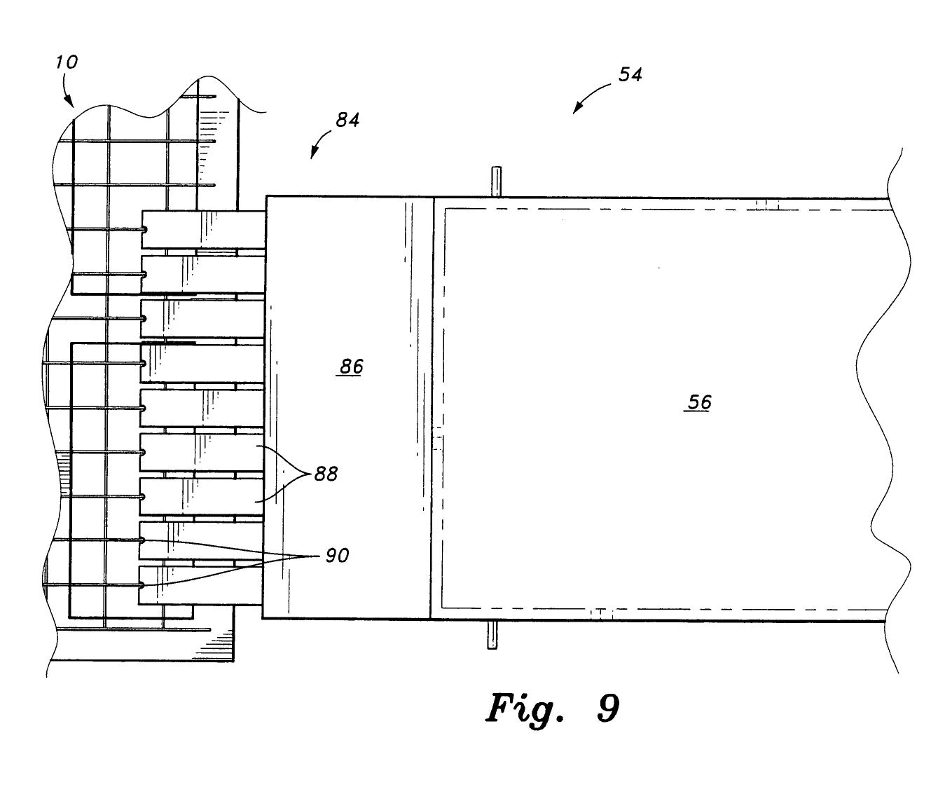

FIGS. 8 and 9 are drawn to the working arm apparatus 54 that is used by a worker to remove the smoked fillet product from the smoking racks 10 and 28 without injury to oneself and the smoked fish fillets for transfer to a packaging station. It should be noted that FIG. 8 has omitted the knife section portion of FIG. 9. A rectangular wooden surface tray board 56 is supported by two longitudinal metal wires 58 joined by the metal width wires 60. An inner positioned upper arm rod 62 is connected to an outer upper arm rod 64 by conventional fasteners (not shown) so as to be adjustable in length to fit the worker's upper arm. On the outer upper arm rod 64 a molded upper plastic arm cuff 66 is fastened by conventional fasteners (not shown) and having hook or loop fastening patches (not shown) on its inner surface for attaching to cooperating loop or hook patches on the worker's uniform (not shown). Similarly, a molded lower plastic arm cuff 68 is fastened to a lower arm support rod 70, and has hook or loop fastening patches (not shown) to fasten to the loop or hook fastening patches of the worker's uniform. A handle guard 72 attached to the rod 70 has an end rod 74 connected by a knurled rod 76 threaded into the lower arm support rod 70, a threaded outer rod 78, and a short handle rod 80. A plastic semi-cylindrical cover 82 is attached to the front face of the knurled rod 76 for protecting the worker's hand. It should be noted that the outer upper arm guard 64 is hinged to the lower arm support rod 70 with a fastener (not shown) so as to be a rotatable elbow joint region. Thus, the inclination of the tray board 56 relative to the planar smoking rack 10 can be readily controlled by the operator.

In FIG. 9, the cutting end portion 84 of the tray board 56 is illustrated to show a rectangular metal knife support 86 having a plurality of planar metal knives 88 tipped with sharp grooved slots 90 which are spaced in parallel and aligned to scrape the smoked fillets off the smoking rack 10.

Thus, an apparatus and method of using the apparatus to more efficiently and effectively handle the packaging of smoked fish fillets has been shown.

It is to be understood that the present invention is not limited to the embodiment described above, but encompasses any and all embodiments within the scope of the following claims.

1. A method of packaging at least one smoked fish fillet comprising:
placing at least one fish fillet having its skin on a rack having equidistantly spaced wires in parallel;
smoking the at least one fish fillet over a smoking fire;
removing the at least one smoked fish fillet stuck to the rack wires with a working arm device having knives traversing the spaced wires of the rack;
transferring the at least one smoked fish fillet to a paper card surface for cooling with the working arm device; and
further transferring the at least one cooled smoked fish fillet with the working arm device to a sealable container or another receiving surface.

2. The method of packaging the at least one smoked fish fillet according to claim 1, wherein the rack is planar.

3. The method of packaging the at least one smoked fish fillet according to claim 1, wherein the rack is cambered.

4. The method of packaging the at least one smoked fish fillet according to claim 1, wherein the movement of the at least one smoked fillet from one surface to another surface is accomplished by the working platform.

5. The method of packaging the at least one smoked the at least one smoked fish fillet according to claim 1, wherein a large fish fillet is sliced cross-wise, placed on a cambered rack and held in position at its ends by spring-powered rack clips.

6. The method of packaging the at least one smoked fish fillet according to claim 5, wherein the spring-powered rack clips are alligator clips with a release handle.

7. The method of packaging the at least one smoked fish fillet according to claim 5, wherein the spring-collared rack clips are configured with two finger hooks with a release handle.

8. The method of packaging the at least one smoked fish fillet according to claim 1, wherein the working arm device is attached to the uniform of a worker.

9. An apparatus system for packaging smoked fish fillets comprising:
a rectangular wire smoking rack elevated on a rectangular planar frame having four open rectangular spaces;
a working platform arm device supporting a planar backing surface tray; and
said backing surface tray having a frontal portion supporting a multiple knife section, wherein the knives are arranged in parallel and each knife has a frontal sharpened groove;
whereby said working platform arm device can scrape off and hold the smoked fish fillets.

10. The apparatus system according to claim 9, wherein the working platform arm device comprises a pair of elongated rods pivotable with a single rod attached to said wire smoking rack.

11. The apparatus system according to claim 10, including a plastic molded form conforming and attachable to a worker's upper arm is attached to the pair of elongated rods.

12. The apparatus system according to claim 10, including a plastic molded form conforming and attachable to a worker's lower arm is attached to the single rod.

13. The apparatus system according to claim 9, including a handle attached to a frontal portion of the single rod.

14. The apparatus system according to claim 9, wherein the rectangular wire smoking rack is cambered for smoking a large fish fillet.

15. The apparatus system according to claim 14, wherein clips are provided for anchoring the fish fillet by its ends on the cambered smoking rack.

16. The apparatus system according to claim 15, wherein the clips are alligator clips having springs for securing the attachment.

17. The apparatus system according to claim 16, wherein the alligator clips have a handle for guiding a smoked fish fillet onto the working platform arm device.

18. The apparatus system according to claim 16, wherein the clips are two-fingered clips having a spring and a hook attached for securing the attachment.

19. The apparatus system according to claim 18, wherein the two-fingered clips have curved fingers and a handle for guiding a smoked fish fillet onto the working platform device.

20. The apparatus system according to claim 19, wherein plastic molded forms are provided for a worker's arms and have hook or loop fastening patches for fastening to the worker's shirt.
